(19) United States
(12) Patent Application Publication
(10) Pub. No.: US 2025/0011589 A1
(43) Pub. Date: Jan. 9, 2025

(54) MOLDED PART OF FLAME RETARDANT ELASTOMER COMPOSITION FOR STRUCTURAL FIRE PROTECTION, AND METHOD OF MANUFACTURING CORRESPONDING MOLDED PARTS

(71) Applicant: Hilti Aktiengesellschaft, Schaan (LI)

(72) Inventors: Daniel Frehner, Memmingen (DE); Wolfgang Schulz-Hanke, Untermeitingen (DE)

(73) Assignee: Hilti Aktiengesellschaft, Schaan (LI)

(21) Appl. No.: 18/712,543

(22) PCT Filed: Nov. 14, 2022
(86) PCT No.: PCT/EP2022/081765

§ 371 Date: May 22, 2024

(30) Foreign Application Priority Data
Nov. 24, 2021 (DE) 10 2021 130 724.4

(51) Int. Cl. C08L 23/16; A62C 3/16; C08K 3/22; C08K 5/14; C08K 11/00; C08L 31/04; F16L 5/04

(52) U.S. Cl. CPC C08L 23/16; A62C 3/16; C08K 3/22; C08K 5/14; C08K 11/00; C08L 31/04; F16L 5/04; C08K 2201/009

(57) ABSTRACT

Molded parts for structural fire protection can be manufactured or are manufactured by vulcanizing a flame retardant elastomer composition. The flame retardant elastomer composition includes a polymer blend of a double bond-containing elastomer and a vinyl acetate-containing thermoplastic polymer, a crosslinker system comprising a sulfur crosslinker or respectively sulfur-containing crosslinker and a peroxide crosslinker, and at least one flame retardant. The sulfur crosslinker or respectively sulfur-containing crosslinker is present in excess over the peroxide crosslinker in the crosslinker system. A method of manufacturing such molded parts is developed. The molded parts are produced for applications having a minimum approved use temperature of −40° C. or less.

The present invention relates to molded parts for structural fire protection which can be manufactured or are manufactured by vulcanizing a flame retardant elastomer composition comprising a double bond-containing elastomer and a vinyl acetate-containing thermoplastic polymer, a crosslinker system comprising a sulfur crosslinker or respectively a sulfur-containing crosslinker and a peroxide crosslinker, and at least one flame retardant, wherein the sulfur crosslinker or respectively sulfur-containing crosslinker is present in excess over the peroxide crosslinker in the crosslinker system. The present invention further relates to methods of manufacturing corresponding molded parts and to the use of the molded parts for applications having a minimum allowable use temperature of −40° C. or less.

### PRIOR ART

Elastic elements, for example made of rubber or respectively caoutchouc, do not of themselves have any flame retardant or fire retardant properties, as required in some applications partly on the basis of standards or statutory regulations, respectively. It is known that elastomers or respectively rubber or natural rubber can have flame retardants or fire retardants added to impart desired flame retardant properties. However, such additives usually lead to an impairment of the elastic properties, which often results in the fact that such an element consisting of rubber or respectively caoutchouc cannot or can no longer fulfill the required elastic properties with regard to desired static and dynamic properties. When used as a spring element or damping element or a similar element that is usually subjected to highly dynamic loads, for example in vehicles, it is therefore not possible to satisfactorily meet the required fire protection regulations.

Because of this problem, it was suggested that the entire element should not be made of elastomer with fire retardant, but that such elements should only be provided with a flame retardant coating. Such composite elements are described, for example, in DE 38 31 894 A1 or WO 2010/069842.

Of essential importance for the properties of an elastomer is the crosslinking system used to transform the initially flowable rubber into an elastomeric material possessing the typical elastomeric properties. Properties such as hardness, modulus, strength, elongation at break, tear resistance and elasticity can be adjusted to the desired level via the type of crosslinking and the crosslink density.

Furthermore, polymeric compositions containing flame retardants are known from the prior art, which can be formed, for example, from mixtures of ethylene vinyl acetate and ethylene propylene diene monomer rubber. These mixtures are crosslinked partly with the aid of silanes, but mostly peroxide or by irradiation.

Such mixtures are mainly used in the sheathing of cables or electric lines. For example, EP 2 343 334 A2 describes flame retardant compositions of EVA, EPDM and LLDPE that are crosslinked with a peroxide crosslinking system based on di-cumyl peroxide. Peroxides are often used as crosslinking agents when rubbers are to be crosslinked that do not contain double bonds and/or when a particularly high crosslink density and tight mesh of the network is to be achieved, which in turn positively influences the mechanical properties such as compression set, in particular at elevated temperatures. On the other hand, the usually high crosslink density and the short crosslink bridges result in a lower elongation at break compared to materials of the same hardness. If the surfaces of the products are no longer processed, peroxide crosslinking requires the exclusion of atmospheric oxygen during the crosslinking process. In addition, peroxide crosslinking systems have a detrimental effect on the elastic and dynamic properties, in particular if the composition also contains large amounts of flame retardant. Finally, periodic crosslinkers also have the disadvantage of being comparatively expensive, particularly when compared to sulfur as a crosslinking agent.

To solve these problems, EP 2 880 093 proposes mixtures of double bond-containing elastomers such as EPDM and vinyl acetate-containing thermoplastic polymer such as EVA, vulcanized exclusively with a sulfur or sulfur-containing crosslinking system. The sulfur crosslinker is intended to ensure that only the double bond-containing elastomer participates in the crosslinking and that a material with high elongation at break is obtained.

In structural fire protection, one usually tries to prevent primarily the passing of smoke gases as well as the transfer of heat due to a fire from one room to the next or from different building areas to adjoining areas. Obviously, a closure of wall or ceiling passages that exist between adjacent rooms or building areas must be considered here for fire protection. Of particular importance here are passages for electrical lines and piping or ventilation flaps.

Conventional elastomer materials that can be used here for sealing purposes often use sulfur crosslinkers, which are said to provide advantageous dynamic properties and good fillability with flame retardants. Reference can be made here by way of example to the aforementioned EP 2 880 093 B1. However, these materials do not have optimal properties in terms of glass transition temperature. This temperature affects the potential use temperature of the material, which becomes inflexible below the glass transition temperature and can no longer provide the desired elastomeric properties. Against this background, it would be desirable to have a material for manufacturing molded bodies for structural fire protection that has the lowest possible glass transition temperature in the vulcanized state, in order to broaden the temperature range that can be covered by such a component. In other areas of use, the material should provide properties that are as equivalent as possible to conventional materials based on double bond-containing elastomers and vinyl acetate-containing thermoplastic polymer. A low glass transition temperature would be particularly advantageous in applications in areas and regions around the world where outside temperatures can drop into the −40° C. range or below, such as pipeline systems in Siberia or the Arctic.

Against this background, there was a need for elastomer compounds for manufacturing molded bodies for structural fire protection and corresponding molded bodies that exhibit mechanical properties as similar as possible to those of products on the market, but which have lower glass transition temperatures compared to these, and thus cover a broader spectrum of use temperatures. The present invention addresses this need.

### DETAILED DESCRIPTION

In the studies on which the present application is based, it was surprisingly found that improved glass transition temperature properties and advantageous elastic and mechanical properties can be obtained when molded bodies are prepared from a composition comprising a double bond-containing elastomer and a vinyl acetate-containing thermoplastic polymer, and this composition is crosslinked with a mixture of a peroxide crosslinker and a sulfur crosslinker or respectively sulfur-containing crosslinker. In this case, a small amount of peroxidic crosslinker is sufficient to realize a noticeably reduced glass transition temperature, such that the peroxide crosslinker can be used in admixture with the sulfur crosslinker or respectively sulfur-containing crosslinker. Due to the reduced glass transition temperature of the crosslinked molded body, a widening of the temperature window in which the molded body with elastomeric properties can be used can be achieved.

In accordance with a first aspect, the present invention thus relates to a molded part for structural fire protection which can be manufactured or is manufactured by vulcanizing a flame retardant elastomeric composition, wherein the elastomeric composition contains i) a double bond-containing elastomer, and ii) a vinyl acetate-containing thermoplastic polymer as polymeric components, wherein the polymeric components are present as a homogeneous polymer blend, a crosslinker system consisting of a sulfur crosslinker or respectively sulfur-containing crosslinker and a peroxide crosslinker, wherein the amount of the peroxide crosslinker is less than that of the sulfur crosslinker or respectively sulfur-containing crosslinker, and contains a flame retardant or a combination of flame retardants.

In this context, the term “molded part for structural fire protection” refers to molded parts used in applications in which the spread of fire or gases, such as fire gases, from one space to another adjacent space or from different building areas to adjoining areas is to be prevented or at least slowed down. Molded parts of this type are usually designed to be inserted in a form-fitting manner into openings in a wall between the rooms or building areas, wherein the openings can have a round, rectangular or square cross-section. In contrast, cable insulation, for example, which is primarily intended to prevent burning of the insulation itself, is not a molded part for structural fire protection within the meaning of the invention described herein. Molded parts for structural fire protection typically have dimensions based on the dimensions of the opening in which they are used, i.e., they have a length equal to or greater than the thickness of the wall, but not significantly greater (for example, no more than five times and preferably no more than twice the wall thickness).

In the context described here, the term “building areas” covers areas of stationary immovable structures (“buildings”), including technical and industrial installations in the onshore and offshore sector, wind power and solar installations, and also movable structures, such as ships in particular, which have areas or units to be separated from one another for the purpose of fire protection to prevent gas exchange.

The specification “for structural fire protection” does not preclude the molded part from performing other functions, such as sealing against the passage of gases, water, sound (to improve acoustics), or pathogens such as bacteria-containing aerosols, molds, or spores thereof. The assumption of such functions is expressly desired and preferred for the molded parts according to the invention.

The use of only a small amount of peroxide crosslinker has the advantage that the cost of the crosslinker system can be minimized.

The double bond-containing elastomer is preferably a homopolymer, copolymer or terpolymer of or with diene monomer units. A terpolymer consisting of ethylene, propylene and a diene-containing termonomer is particularly suitable, preferably with a termonomer content of at least 2% by weight to 12% by weight based on the terpolymer.

It is particularly advantageous if the elastomer contained in double bonds is a rubber with an unsaturated side group, in particular an ethylene-propylene-diene rubber (EPDM). Ethylene-propylene-diene monomer rubbers (EPDM) have great advantages in the event of fire in terms of their low smoke density and toxicity, but are not themselves fire-resistant. On the other hand, EPDM rubbers are highly fillable with fillers and plasticizers and can thus absorb a high proportion of flame retardants in solid and liquid form. The hardness and mechanical properties of EPDM rubbers can thus be adjusted over a wide area, and the rubbers have advantages in terms of resistance to weathering, UV, ozone and heat.

EPDM rubbers particularly useful in the flame retardant elastomer composition from which the molded body of the invention is formed comprise non-conjugated diene monomer units selected from the group consisting of 1,3-butadiene, 2-methyl-1,3-butadiene (isoprene), 2,3-dimethyl-1,3-butadiene, 1,3-pentadiene, 1,3-cyclopentadiene, dicyclopentadiene, 2-methyl-1,3-pentadiene, 1,3-hexadiene, 1,4-hexadiene, 1,4-cyclohexadiene, tetrahydroindene, methyltetrahydroindene, ethylidene norbornene or respectively 5-ethylidene-2-norbornene (ENB), 5-methylene-2-norbornene (MNB), 1,6-octadiene, 5-methyl-1,4-hexadiene, 3,7-dimethyl-1,6-octadiene, 5-iso-propylidene-2-norbornene and 5-vinyl-norbornene. It is particularly advantageous if the ethylene-propylene-diene monomer rubber (EPDM) is a terpolymer of ethylene, propylene and 5-ethylidene-2-norbornene (ENB) or dicyclopentadiene (DCPD), preferably with a termonomer content of at least 2 to 12% by weight and in particular 4 to 12% by weight based on the terpolymer (in accordance with ASTM D 6047). Most preferred as a diene component of EPDM rubber is 5-ethylidene-2-norbornene (ENB).

In the investigations underlying the present invention, it was also found that very favorable properties can be obtained when the EPDM is formed from a mixture of two EPDM grades, one having a diene content in the range of 8 to 12% by weight and the other having a diene content in the range of 4 to 7% by weight. In addition, other EPDM grades may also be present in this case, but these are then preferably present in the mixture in an amount of not more than 5% by weight and, in particular, not more than 2% by weight, based on the total amount of EPDM with high and low diene content. In a mixture, the EPDM with a diene content in the range of 8 to 12% by weight preferably constitutes the predominant proportion of the EPDM (i.e., 50 to 95% by weight and preferably 60 to 80% by weight of the total EPDM in the mixture).

The thermoplastic vinyl acetate-containing polymer to be included in the elastomer composition from which the molded body of the invention is formed is preferably a homopolymer, copolymer or terpolymer of vinyl acetate, and particularly preferably polyvinyl acetate (PVAc) or ethylene vinyl acetate (EVA). For an ethylene vinyl acetate copolymer, it is preferred to have a vinyl acetate content in the range of 40 to 75% by weight and particularly in the range of 50 to 65% by weight.

Alternatively, or additionally, it is preferred if the vinyl acetate-containing polymer has a melting temperature or an onset of the melting range of less than 150° C., preferably less than 100° C.

The ratio of polymeric components i) and ii) in the elastomer composition according to the invention is preferably in the range from 5:1 to 20:1 and in particular 6:1 to 12:1, i.e., the double bond-containing elastomer is present in excess over the vinyl acetate-containing thermoplastic polymer.

All peroxidic crosslinkers known to those skilled in the art can be considered as peroxidic crosslinkers in the crosslinking system of the present invention. Dialkyl peroxides and ketal peroxides are particularly useful. Suitable dialkyl peroxides include dicumyl peroxide, di-t-butyl peroxide, t-butyl-cumyl peroxide, 2,5-dimethyl-2,5-bis(t-butylperoxy)-hexane, 2,5-dimethyl-2,5-bis(t-butylperoxy)-hexine-(3), alpha, alpha′-bis(t-butylperoxy)-diisopropylbenzene, di-t-amyl peroxide, 1,3,5-tris(2-t-butylperoxy-isopropyl) benzene. 1-phenyl-1-t-butylperoxy-phthalide. Suitable ketal peroxides include 1,1-bis(t-butylperoxy)-3,3,5-trimethyl-cyclohexan, 1,1-bis(t-butylperoxy)-cyclohexan, 2,2′-bis(t-butylperoxy)-butan, ethyl-3,3-bis(t-butylperoxy)-butyrat, n-nutyl-4,4-bis(t-butylperoxy)-valerat. Particularly preferred in the context of the present invention is the use of 2,5-dimethyl-2,5-bis(t-butylperoxy)-hexane.

The proportion of the peroxide crosslinker, based on the polymer blend, is preferably 0.2 to 1.5 phr and more preferably 0.5 to 1.2 phr, wherein “phr” refers to the total amount of double bond-containing elastomer and vinyl acetate-containing thermoplastic polymer included in the polymer blend.

Sulfur (e.g., in the form of ground sulfur), or a sulfur-containing crosslinker such as bis [3-(triethoxysilyl) propyl]polysulfide or a mixture thereof may be used as the sulfur crosslinker in the elastomer compositions of the invention.

The proportion of the sulfur crosslinker or respectively sulfur-containing crosslinker, based on the polymer blend, is preferably in the range of from 1 to 7 phr, in particular 2 to 5 phr and particularly preferably 2.8 to 4.0 phr.

For the purpose of the present invention, it is essential that the sulfur crosslinker or respectively sulfur-containing crosslinker be present in excess over the peroxide crosslinker, wherein an excess denotes a higher percentage by weight of the total amount of the sulfur crosslinker or respectively sulfur-containing crosslinker over the peroxide crosslinker. Preferably, peroxide crosslinker and sulfur crosslinker or respectively sulfur-containing crosslinker are present in a ratio of about 1:1.5 to 1:5, in particular 1:2 to 1:4 and particularly preferably 1:2.5 to 1:3.8.

The flame retardant to be included in the molded parts according to the invention is not subject to any relevant limitations, such that the flame retardant can be, for example, an expandable flame retardant (such as expandable graphite) or a water-splitting flame retardant, such as a metal hydroxide. In order to achieve good fire protection properties while affecting the material properties as little as possible, it has proven advantageous if magnesium hydroxide (MDH), aluminum hydroxide (ATH), antimony trioxide, nanoclays and/or zinc borate, preferably a synergistically acting mixture of two or more thereof, are included in the elastomer composition according to the invention. Preferably, the elastomer composition according to the invention contains aluminum hydroxide, either alone or in mixture with other flame retardants. In particular, the flame retardant(s) is/are thereby solid and powdery or crystalline.

In most cases, the flame retardant is present in the elastomer composition in a comparatively large proportion. Preferably, the elastomer composition contains a proportion of 100 to 300 phr, and in particular 140 to 250 phr. of flame retardant. If the flame retardant content falls below this level, it may in individual cases no longer be possible to guarantee a sufficient flame retardant effect, while a higher proportion of flame retardant may have a significantly unfavorable effect on the mechanical properties, such as tensile strength, elongation at break, tear resistance, or elasticity.

In addition to the ingredients mentioned in the foregoing, the elastomer composition for manufacturing molded bodies according to the invention may contain further additives and/or auxiliaries to desirably control the final properties of the molded body.

An important class of such additives that can be used to control vulcanization or crosslinking are accelerators, each of which can specifically accelerate sulfur crosslinking or peroxide crosslinking. Commonly used accelerators for sulfur crosslinking include sulfenamides, e.g., N-cyclohexyl-2-benzothiazylsulfenamide (CBS), thiazoles, e.g., 2-mercaptobenzothiazole (MBT), dithiocarbamates, e.g., zinc dibenzyl dithiocarbamate (ZBEC), or zinc dibutyl dithiocarbamate (ZDBC), guanidines, e.g., diphenylguanidine (DPG), or thiophosphates. Suitable sulfur donors that can be added to control sulfur crosslinking include thiurams such as tetramethythiuram disulphide (TMDT) or tetramethythiurammon sulphide (TMTM), caprolactam disulfide or phosphoryl polysulfide. Such accelerators and sulfur donors can conveniently be included in the elastomer composition according to the invention in a total proportion of 1 to 5 phr.

Antioxidants can be used to support peroxide crosslinking such as 2,2,4-trimethyl-1,2-dihydroquinoline (TMQ) or 1,3-dihydro-4 (or 5)-methyl-2H-benzimidazole-2-thione. Such antioxidants and sulfur donors may be present at a total proportion of 1 to 5 phr in the elastomer composition.

In addition, the elastomer compositions may contain plasticizers, e.g., in the form of paraffinic mineral oils, or processing aids, e.g., in the form of Ca and Zn soaps of fatty acids, fatty alcohols or low molecular weight polyethylene or polyethylene glycol.

Furthermore, additives such as ZnO or MgO can be added to improve the heat stability, and/or pigments for coloring or imparting UV protection such as TiO₂, UV stabilizers or carbon black can be added. The proportion of plasticizers is preferably in the range of 5 to 50 phr, in particular 10 to 30 phr and more preferably 12 to 25 phr. Other auxiliaries and additives are expediently included in the flame retardant elastomer composition at a maximum proportion of 20 phr and in particular 15 phr.

As a flame retardant composition particularly suitable in the context of the present invention for manufacturing molded bodies according to the invention, a composition may be disclosed as follows:
mixture of double bond-containing elastomer and vinyl acetate-containing thermoplastic polymer;
130 to 250 phr flame retardant, preferably in the form of aluminum hydroxide;
10 to 30 phr plasticizer;
1 to 5 phr each of sulfur donors/accelerators of sulfur vulcanization and antioxidants;
5 to 30 phr, and preferably 8 to 15 phr, of other additives and auxiliaries,
a crosslinker system comprising a sulfur crosslinker or respectively sulfur-containing crosslinker and a peroxide crosslinker, wherein the amount of the peroxide crosslinker is less than that of the sulfur crosslinker or respectively sulfur-containing crosslinker.

For use for fire protection purposes, it is preferred if the molded bodies according to the invention manufactured from the flame retardant elastomer composition do not contain any relevant amounts of halogens, since toxic hydrogen halides can be released from halogen-containing compounds in the event of fire. For the molded bodies according to the invention, it is therefore preferred that the polymeric component(s) of the elastomer composition, and preferably the entire composition, is/are halogen-free.

The molded body according to the invention can be formed exclusively from the flame retardant elastomeric compound, or comprise further components, e.g., reinforcing agents. In one embodiment, the surface of the molded body is formed exclusively of the flame retardant elastomeric mixture, while another material is present inside the molded body.

As already mentioned, the molded parts according to the invention are molded parts which can be used in structural fire protection and the dimensions of which are usually matched to wall thicknesses in which the molded part is to be used. It is preferred here if the molded part according to the invention has an aspect ratio of at most 10, and particularly preferred at most 5. The “aspect ratio” here refers to the ratio of the largest to the smallest spatial extent of the molded part.

In a particularly preferred embodiment, the molded part according to the invention is ventilation flaps or components thereof. In another particularly preferred embodiment, the molded part according to the invention is a device for the fire-resistant passage of conduits, cables, tubes and the like through openings located in walls or shafts, which are formed with at least one rectangular supporting frame. In this case, the device includes one or more packing pieces having channels of the flame retardant elastomeric composition extending the depth of the rectangular supporting frame which can be inserted into the rectangular supporting frame.

For the purpose of clarification, it is noted that here the molded part according to the invention refers to the device as a whole, which may, however, be formed from a plurality of individual parts (in particular a plurality of packing pieces and, where appropriate, further components). The rectangular supporting frame is not part of the device in this case.

In a preferred embodiment, the device includes at least one unit of two packing pieces formed from two symmetrically shaped sealing elements, wherein the sealing elements have one or more approximately semi-cylindrical recesses and are arranged one on top of another such that one or more cylindrical recesses are formed. Expediently, in this case, the device may have two semi-cylindrical inserts, each of which is formed with semi-cylindrical recesses, and arranged against one another in such a manner that the recesses form a channel adapted for the insertion of a conduit.

The device can contain exactly two packing pieces (=one pair), or a multiple of two packing pieces, which can be inserted into the rectangular supporting frame (for example in pair arrangements of 2×2, 3×2, 4×2 or 4×4). In the case of an odd number of pairs of packing pieces, the space left free in relation to the rectangular supporting frame can be filled by a molded body the dimensions of which are exactly matched to the space left free (as a “filler module”). Such a filler module is expediently also formed from a flame retardant elastomer composition as described above. Likewise, a plurality of such filler modules can be arranged in the rectangular supporting frame, which in combination with the packing pieces form the device.

For the device described above, it is further preferred if the wall delimiting the recess in the sealing elements is formed with semi-annular ribs and between these with semi-annular grooves. Some of these grooves may be formed with recesses that preferably extend over only a part of the semi-annular wall. For this embodiment, it is further preferred if the semi-cylindrical inserts are provided with projections corresponding to the grooves and recesses of the walls delimiting the sealing elements, which projections engage in the grooves and recesses in such a manner that the inserts can neither be displaced in the direction of the formed channel nor rotated around this channel when the inserts are arranged in the sealing elements. In this manner, inserts inserted in the sealing elements are prevented from shifting or rotating. Such sealing elements are described in detail, for example, in EP 1 134 472 B1, the relevant contents of which are hereby incorporated by reference in their entirety in this application.

If the device has semi-cylindrical inserts, the device may further have molded body components the dimensions of which are adapted to the dimensions of the channel formed by the semi-cylindrical inserts, and which may be inserted into the semi-cylindrical inserts as placeholders for later occupation of the channels with cables. Preferably, these placeholders also have projections that can engage in corresponding recesses in the semi-cylindrical inserts and fix the position of the placeholder in the inserts. Preferably, placeholders are also formed from a flame retardant elastomeric composition as described in the foregoing.

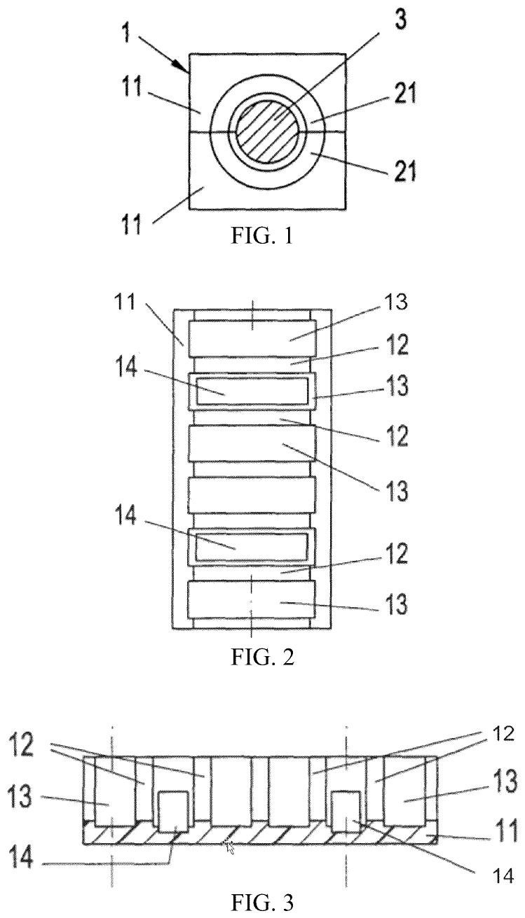

The devices described above are illustrated in more detail in FIGS. 1 to 5. In the drawings:

FIG. 1: shows a front view of a packing piece with two sealing elements

FIG. 2: shows a top view of a sealing element

FIG. 3: shows a sealing element in longitudinal section

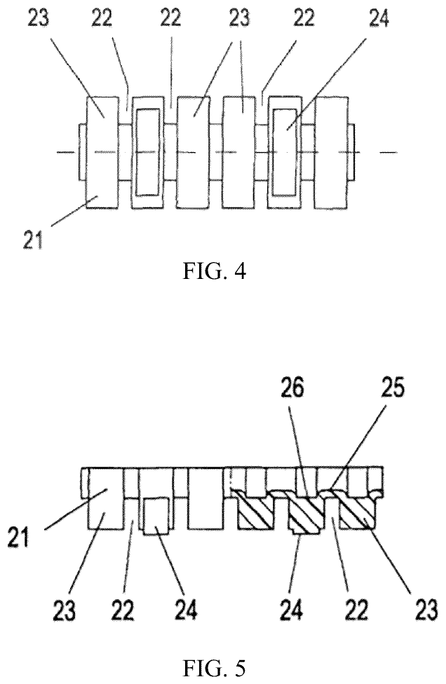

FIG. 4: shows a top view of an insert

FIG. 5: shows a side view of an insert

The cuboidal packing piece 1 shown in FIG. 1 consists of two symmetrically formed sealing elements 11, each of which is formed with an approximately semi-cylindrical recess and which serve to receive semi-cylindrical inserts 21, which are likewise formed with semi-cylindrical recesses. A conduit 3 can be inserted into the through channel formed hereby. The sealing elements 11 and the inserts 21 located in them must be designed in such a manner that they tightly enclose the conduit 3 in order to ensure the desired safety against the passage of fire gases.

FIGS. 2 and 3 show a top view and a longitudinal section of a sealing element 11, which has ribs 12 and grooves 13, as well as additional recesses 14 which, unlike the grooves 13, do not extend over the entire semicircular inner surface of the sealing element.

FIGS. 4 and 5 show a top and side view of an insert 21, which has grooves 22 and ribs 23, as well as projections 24. FIG. 5 also shows semi-annular ribs 25 and semi-annular grooves 26 between them on the inner wall of the inserts. The ribs can be used to compensate for differences in the thickness of an inserted cable to a certain extent that the ribs can push away due to the given flexibility. When an insert is inserted into a sealing element, the ribs 23 and projections 24 engage corresponding grooves 13 and recesses 14 in the sealing element.

In a further aspect, the present invention relates to the use of molded parts, as described in detail above, for structural fire protection applications, wherein the molded parts are preferably inserted into a wall opening or a wall opening between two rooms, and sealingly close this opening in the contact area of the molded part and the wall. In such a use, pipes or other conduits may be integrated or inserted into the molded part.

In a further aspect, the present invention relates to a method of manufacturing the molded bodies described above, the method comprising the steps of
a) mixing the aforementioned polymeric components to form a homogeneous mixture and, in particular, subsequently incorporating the crosslinking system, the flame retardants and optionally further additives and/or auxiliaries while avoiding crosslinking and/or vulcanization, and
b) introducing said mixture into a molding tool,
c) subsequent vulcanization of the mixture, and
d) demolding of the molded bodies formed in c).

Mixing is expediently performed under conditions at which no crosslinking or respectively vulcanization occurs, i.e., preferably at a temperature of 110° C. or less. The subsequent vulcanization can be performed at elevated temperature, e.g., in the range of 130° C. to 200° C. and in particular 130° C. to 170° C., and optionally under pressure. During vulcanization, crosslinking of the polymer components occurs as a result of activation of the crosslinkers.

The elastomer composition used to manufacture the molded bodies according to the invention preferably has at least one of the following properties after vulcanization:
i) a glass transition temperature, determined by DSC, of at most-39° C., in particular at most −40° C., and particularly preferably at most −41° C.;
ii) a compression set, determined in accordance with DIN ISO 815 at 70° C./24 h, in the range of 10 to 40% and preferably 15 to 25% and/or a compression set, determined in accordance with DIN ISO 815 at 100° C./24 h, in the range of 45 to 75% and preferably 55 to 68%;
iii) a Shore A hardness, determined in accordance with DIN ISO 7619-1 (2012) of 65 to 85, preferably 70 to 83;
iv) an elongation at break, determined in accordance with DIN 53504, of 200 to 600%, preferably of 300 to 500%;
v) a tear resistance, determined in accordance with DIN ISO 34-1 A, of >2.5 N/mm, preferably >3.5 N/mm.

A still further aspect of the present invention relates to the use of a molded part as described above for applications having a minimum allowable use temperature of-40° C. or less. Preferred uses of this type include wall or ceiling breakthroughs in buildings, technical and industrial installations in the onshore and offshore sector, wind power and solar installations, and ships or the like of pipelines and cables, particularly when located in areas and regions around the world where very low outdoor temperatures in the range of up to −40° C. can occur.

A further aspect of the present invention relates to the use of a molded part as described above for sealing buildings against water, gas, sound, or pathogens, particularly in the form of bacteria or mold.

For these aspects, the preferred embodiments explained in connection with the molded parts according to the invention apply, in an analog manner also as preferred, unless this results in a contradiction.

In the following. the present application will be illustrated in more detail by means of some embodiments, which, however, are not to be regarded as limiting the scope of the application in any way.

### EXAMPLES

The composition given in Table 1 below was homogenized in a mixer and then vulcanized at a temperature of 180° C. for 10 min (2 mm thick sheets) or 20 min (6 mm thick sheets) under a nitrogen atmosphere. Subsequently the mechanical properties of the plates were determined. To determine the glass transition temperature, the mixture was first equilibrated for 15 min at-120° C. and then heated to 250° C. at a heating rate of 10 K/min. The glass temperature was determined as midpoint Tg in accordance with DIN 51007. The determined mechanical properties are also given in Table 1 below.

TABLE 1

| | | |
|---|---|---|
| Component | E1 | V1 |

| EPDM with diene content of about 11% | 74 | | 74 | |
|---|---|---|---|---|
| EPDM with diene content of about 5% | 16 | | 16 | |
| EVM with about 60% vinyl acetate | 10 | | 10 | |
| aluminum hydroxide | 180 | phr | 180 | phr |
| Sulfur crosslinker | 3.4 | phr | 3.4 | phr |
| Peroxide crosslinker | 1 | phr | — | |
| Mineral oil (plasticizer) | 15 | phr | 15 | phr |
| Antioxidants | 2.4 | phr | 2.4 | phr |
| Accelerator/sulfur donor | 2.8 | phr | 2.8 | phr |
| ZnO | 3.8 | phr | 3.8 | phr |

| | | |
|---|---|---|
| Compression set 22 h 70° C.¹ | 21% | 43% |
| Compression set 22 h 100° C.¹ | 61% | 75% |

| | | |
|---|---|---|
| Glass transition temperature [° C.]² | −41.2 | −38.8 |

| | | |
|---|---|---|
| Elongation at break [%]³ | 430% | 360% |

| | | |
|---|---|---|
| Tensile strength [MPa]³ | 4.9 | 4.6 |
| Tear resistance [N/mm]⁴ | 3.5 | 4.5 |

*average from 2 measurements (in N2);
¹determined in accordance with DIN ISO 815;
²determined in accordance with DSC;
³determined in accordance with DIN 53504;
⁴determined in accordance with DIN ISO 34-1 A.

It is clear from Table 1 that a reduction in the glass transition temperature of about 2.6° C. was observed for combined crosslinking with sulfur and peroxide accelerator, despite otherwise comparable mechanical properties. This change allows the use of appropriate elastomer formulations for applications with very low extreme temperatures.

In an analogous measurement of the glass transition temperature in an air atmosphere, a Tg of −41.5° C. was determined for E1 and a Tg of −39.1° C. for V1 (mean value from 2 measurements).

1. A molded part for structural fire protection, comprising a vulcanized flame retardant elastomer composition, the flame retardant elastomer composition comprising:
a double bond-containing elastomer and
a vinyl acetate-containing thermoplastic polymer as polymeric components, wherein the polymeric components are present as a homogeneous polymer blend;
a crosslinker system of a sulfur crosslinker or respectively sulfur-containing crosslinker and a peroxide crosslinker, wherein an amount of the peroxide crosslinker is less than that of the sulfur crosslinker or respectively sulfur-containing crosslinker; and
a flame retardant or a combination of flame retardants.

2. The molded part in accordance with claim 1, wherein the peroxide crosslinker is present in the polymer blend of the flame retardant elastomer composition in a proportion of 0.2 to 1.5 phr.

3. The molded part in accordance with claim 1, wherein the sulfur crosslinker or respectively sulfur-containing crosslinker is present in the polymer blend of the flame retardant elastomer composition in a proportion of 1 to 7 phr.

4. The molded part in accordance with claim 1, wherein the double bond-containing elastomer in the flame retardant elastomer composition is a homopolymer, copolymer or terpolymer of or respectively with diene monomer units.

5. The molded part in accordance with claim 1, wherein the double bond-containing elastomer in the flame retardant elastomer composition is an ethylene-propylene-diene rubber (EPDM) having an unsaturated pendant group and having at least one non-conjugated, diene monomer unit selected from the group consisting of 1,3-butadiene, 2-methyl-1,3-butadiene (isoprene), 2,3-dimethyl-1,3-butadiene, 1,3-pentadiene, 1,3-cyclopentadiene, dicyclopentadiene, 2-methyl-1,3-pentadiene, 1,3-hexadiene, 1,4-hexadiene, 1,4-cyclohexadiene, tetrahydroindene, methyl tetrahydroindene, ethylidene norbornene, respectively 5-ethylidene-2-norbornene (ENB), 5-methylene-2-norbornene (MNB), 1,6 octadiene, 5-methyl-1,4-hexadiene, 3,7-dimethyl-1,6-octadiene, 5-iso-propylidene-2-norbornene, and 5-vinyl-2-norbornene (VNB).

6. The molded part in accordance with claim 1, wherein the vinyl acetate-containing thermoplastic polymer in the flame retardant elastomer composition is a homopolymer, copolymer or terpolymer of the vinyl acetate and in particular is selected from the group consisting of polyvinyl acetate (PVAc) and ethylene vinyl acetate (EVA), and/or wherein the vinyl acetate-containing thermoplastic polymer has a melting temperature or respectively onset of a melting range of less than 150° C., and/or in that wherein the vinyl acetate-containing polymer has a vinyl acetate content of 40 to 75% by weight.

7. The molded part in accordance with claim 1, wherein the polymeric components in the flame retardant elastomer composition are present in the elastomer composition in a ratio of 5:1 to 20:1.

8. The molded part in accordance with claim 1, wherein the peroxide crosslinker in the flame retardant elastomer composition is present in the composition in a form of dialkyl peroxides.

9. The molded part in accordance with claim 1, wherein the flame retardant in the flame retarded elastomer composition is selected from the group comprising metal hydroxides.

10. The molded part in accordance with claim 1, wherein the flame retardant is present in the flame retardant elastomer composition in a proportion of 100 to 300 phr.

11. The molded part in accordance with claim 1, wherein the flame retardant elastomer composition further comprises at least one additive and/or auxiliary selected from the group comprising colorants.

12. The molded part in accordance with claim 1, wherein the polymeric component(s) of the flame retardant elastomer composition is/are halogen-free.

13. The molded part in accordance with claim 1, wherein the flame retardant elastomer composition forming the molded part has a Shore A hardness, determined in accordance with DIN ISO 7619-1 (2012) in a range of 65 to 85 and/or a glass transition temperature of at most −39° C.

14. The molded part in accordance with claim 1. having an aspect ratio of at most 10.

15. The molded part in accordance with claim 1, wherein the molded part is designed as a device for a fire-proof passage of conduits, cables, tubes and the like through openings located in walls or shafts, having at least one rectangular supporting frame, wherein the device has one or more packing pieces with channels of an elastic material extending over a depth of the rectangular supporting frame, wherein the packing pieces can be inserted into the rectangular supporting frame.

16. The molded part in accordance with claim 15, wherein the device includes a plurality of packing pieces formed from two symmetrically formed sealing elements, wherein the sealing elements have an approximately semi-cylindrical recess and are arranged one on top of another in such a manner that a cylindrical recess is formed, so that the recesses form a channel adapted for the insertion of a conduit.

17. The molded part in accordance with claim 16, wherein a wall delimiting the recess in the sealing elements is formed with semi-annular ribs and between these with semi-annular grooves, of which some of the grooves may be formed with recesses.

18. The molded part in accordance with claim 17, wherein the semi-cylindrical inserts are provided with ribs, projections corresponding to the grooves, and recesses of the walls delimiting the sealing elements, which engage in the grooves and recesses in such a manner that the inserts can neither be displaced in the direction of the formed channel nor rotated around this channel when the inserts are arranged in the sealing elements.

19. A method of manufacturing the molded part in accordance with claim 1, the method comprising;
mixing the polymeric components, as indicated in claim 1, to form a homogeneous mixture;
introducing said homogeneous mixture into a molding tool;
subsequent vulcanization of the homogeneous mixture; and
demolding of the molded part.

20. The molded part in accordance with claim 1, wherein the molded part is provided for applications having a minimum permitted use temperature of −40° C. or less.
